(19) United States
(12) Patent Application Publication
(10) Pub. No.: US 2018/0183967 A1
(43) Pub. Date: Jun. 28, 2018

(54) DISPLAY APPARATUS AND CONTROL METHOD THEREOF

(71) Applicant: SAMSUNG ELECTRONICS CO., LTD., Suwon-si (KR)

(72) Inventor: Kyu-heon LEE, Hwaseong-si (KR)

(73) Assignee: SAMSUNG ELECTRONICS CO., LTD., Suwon-si (KR)

(21) Appl. No.: 15/672,760

(22) Filed: Aug. 9, 2017

(30) Foreign Application Priority Data
Dec. 22, 2016 (KR) 10-2016-0176461

(51) Int. Cl. H04N 1/21; H04N 1/405; H04N 1/031

(52) U.S. Cl. CPC H04N 1/212; H04N 1/0282; H04N 1/0316; H04N 1/4056

(57) ABSTRACT

A display apparatus is provided. The display apparatus includes a display panel, a backlight unit configured to provide light to the display panel, and a processor configured to identify a plurality of areas in an image fame, calculate a motion value corresponding to each of the plurality of areas, and control a driving signal for a backlight driver based on one of the plurality of areas according to the calculated motion value.

### CROSS-REFERENCE TO RELATED APPLICATION

This application is based on and claims priority under 35 U.S.C. § 119 to Korean Patent Application No. 10-2016-0176461, filed in the Korean Intellectual Property Office on Dec. 22, 2016, the disclosure of which is incorporated by reference herein in its entirety.

### BACKGROUND

### 1. Field

Apparatuses and methods consistent with exemplary embodiments relate to a display apparatus and a control method thereof, and more particularly, to a display apparatus including a backlight unit and a control method thereof.

### 2. Description of Related Art

The backlight unit included in the display apparatus may include a plurality of light sources. There are two methods for controlling a plurality of light sources.

First, there is a method of controlling a plurality of light sources individually through a backlight scanning method to minimize blur. In this case, a circuit for individually controlling a plurality of light sources must be included, which increases the manufacturing cost. Further, when the scan direction of the display panel is different from the backlight structure, the blur may not be improved.

Next, there is a method of simultaneously controlling a plurality of light sources through a blinking method. In this case, the manufacturing cost can be reduced because the control circuit is simpler than when the backlight scanning method is used. However, there may be a problem that blur only in a specific area in which the scan timing of the display panel and the turn-on times of a plurality of light sources are synchronized is reduced, and blur occurs in the remaining area.

Accordingly, there is a need to develop a method for minimizing blur while using a blinking scheme to reduce manufacturing costs.

### SUMMARY

One or more exemplary embodiments provide a display apparatus for controlling a backlight unit to minimize motion blur and a controlling method thereof.

According to an aspect of an exemplary embodiment, there is provided a display apparatus including: a display panel; a backlight unit configured to provide light to the display panel; and a processor configured to identify a plurality of areas in an image frame, to calculate a motion value corresponding to each of the plurality of areas, and to control a driving signal for driving the backlight unit based on one of the plurality of areas according to the calculated motion value.

The processor may control the driving signal based on an area having a largest value among motion values corresponding to the plurality of areas.

The driving signal may be a pulse width modulation (PWM) signal, and the processor may adjust a duty cycle of the PWM signal based on one of the plurality of areas.

The processor may identify a target duty timing based on a scan timing of one of the plurality of areas, and adjust a duty cycle of the PWM signal based on the target duty timing.

The processor may sequentially change a duty timing of the plurality of image frames based on the target duty timing.

The processor may identify the target duty timing based on a scan timing of a predetermined scan line among a plurality of scan lines included in one of the plurality of areas.

The processor may identify the plurality of areas based on a scanning direction of an image signal corresponding to the image frame.

The processor configured identifies a plurality of image areas in a plurality of image frames. The plurality of image frames may be identified based on at least one of a predetermined time unit, a scene unit, and a predetermined frame unit.

The backlight unit may include a plurality of light sources, and the processor may simultaneously control a turn-on time point of the plurality of light sources based on the driving signal.

According to an aspect of an exemplary embodiment, there is provided a controlling method of a display apparatus including a display panel and, a backlight unit configured to provide light to the display panel, the method comprising: dividing a plurality of areas in an frame; calculating a motion value corresponding to each of the plurality of areas; and controlling a driving signal for driving the backlight unit based on one of the plurality of areas according to the calculated motion value.

The controlling may include controlling the driving signal based on an area having a largest value among motion values corresponding to the plurality of areas.

The driving signal may be a PWM signal, and the controlling may include adjusting a duty cycle of the PWM signal based on one of the plurality of areas.

The controlling may include determining a target duty timing based on a scan timing of one of the plurality of areas, and adjusting a duty cycle of the PWM signal based on the target duty timing.

The controlling may include sequentially changing a duty timing of the plurality of image frames based on the target duty timing.

The controlling may include determining the target duty timing based on a scan timing of a predetermined scan line among a plurality of scan lines included in one of the plurality of areas.

The dividing may include dividing the plurality of areas based on a scanning direction of an image signal.

The processor configured identifies a plurality of image areas in a plurality of image frames. The plurality of image frames may be identified based on at least one of a predetermined time unit, a scene unit, and a predetermined frame unit.

The backlight unit includes a plurality of light sources, and the method may further include simultaneously controlling a turn-on time point of the plurality of light sources based on the driving signal.

According to an aspect of an exemplary embodiment, there is provided a non-transitory recording medium storing a program for executing an operation method of a display apparatus including a display panel and, a backlight unit configured to provide light to the display panel, wherein the operation method comprises: identifying a plurality of areas in an image frame; calculating a motion value corresponding to each of the plurality of areas; and controlling the driving signal based on one of the plurality of areas according to the calculated motion value.

According to the above-described various exemplary embodiments, a display apparatus may adaptively control the backlight unit based on the motion value of the image, thereby minimizing the motion blur and providing a clearer image to the user.

### BRIEF DESCRIPTION OF THE DRAWINGS

The above and other aspects of one or more exemplary embodiments will become more apparent by reference to specific embodiments thereof which are illustrated in the appended drawings. Understanding that these drawings depict only exemplary embodiments of the disclosure and are not therefore to be considered to be limiting of the scope of the disclosure, the principles herein are described and explained with additional specificity and detail through the use of the accompanying drawings, in which:

FIG. 1 is a diagram illustrating a display apparatus according to an exemplary embodiment;

FIGS. 2A to 2C are diagrams illustrating operations of a display apparatus according to an exemplary embodiment;

FIG. 3 is a diagram illustrating a method for setting a reference area according to an exemplary embodiment;

FIG. 4 is a diagram illustrating a reference of target duty timing according to an exemplary embodiment;

FIG. 5 is a diagram illustrating a method of controlling a driving signal according to an exemplary embodiment;

FIGS. 6A to 6C are diagrams illustrating a color recognized by a user according to turn-on and turn-off time points of the backlight unit according to various exemplary embodiments; and

FIG. 7 is a flowchart illustrating a control method of the display apparatus according to an exemplary embodiment.

### DETAILED DESCRIPTION

Hereinafter, various embodiments of the present disclosure will be described in detail with reference to the accompanying drawings.

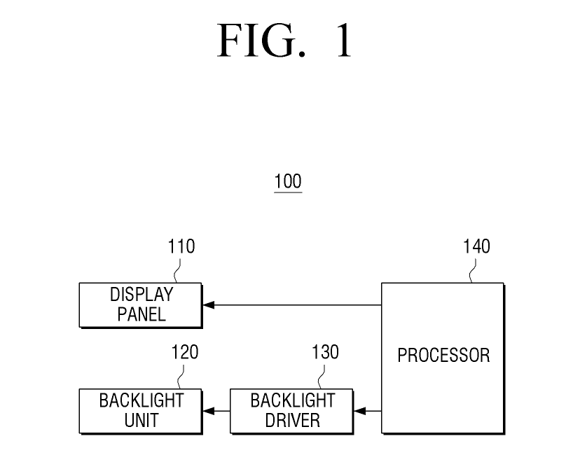

FIG. 1 is a diagram illustrating a display apparatus 100 according to an exemplary embodiment. According to FIG. 1, the display apparatus 100 includes a display panel 110, a backlight unit 120, a backlight driver 130, and a processor 140.

The display apparatus 100 may be realized as various forms of apparatuses, such as TV, smartphone, tablet PC, desktop PC, notebook PC, electronic board, electronic table, large format display (LFD), and the like.

The display panel 110 may display image content. For example, the display panel 110 may display the image content by adding color information for each pixel to light provided (or emitted or radiated) from the backlight unit 120.

The display panel 110 may include a plurality of pixels. Herein, the plurality of pixels may consist of R (Red), G (Green), and B (Blue). Thus, the display panel 110 may be configured by arranging the pixels consisting of R, G, B of pixels toward a plurality of lines and columns. In this case, the display panel 110 may be realized as a liquid crystal display (LCD) panel, etc., and may include any panel that requires a backlight unit 120.

The backlight unit 120 may provide light to the display panel 110. That is, the backlight unit 120 is an element to provide light to the display panel 110.

In particular, when the display panel 110 is a non-light emitting element that is not self-luminous, the display panel 110 may include the backlight unit 120 to provide light to the display panel 110.

The backlight unit 120 may include a plurality of light sources, and a turn-on time point and a turn-off time point of the plurality of light sources may be the same.

The backlight unit 120 may include a plurality of light sources, and the plurality of light sources may include a linear light source such as a lamp or a point light source such as a light emitting diode, although not limited thereto. The backlight unit 120 may be implemented as a direct type backlight unit or an edge type backlight unit. The light source of the backlight unit 120 may include any one, or two or more of a light providing diode (LED), a hot cathode fluorescent lamp (HCFL), a cold cathode fluorescent lamp (CCFL), and an external electrode fluorescent lamp (EEFL).

The processor 140 drives the backlight unit 120. In this case, the processor 140 may be implemented to include an analog driver IC or a digital driver IC for panel driving. In particular, if the processor 140 is implemented as a DSP, the processor 140 may be implemented in the form of one chip with a digital driver IC.

However, for convenience of description, hereinafter, it is assumed that the backlight driver 130 is implemented separately from the processor 140.

The backlight driver 130 may drive the backlight unit 120 based on a driving signal. In detail, the backlight driver 130 may provide a driving signal for controlling a turn-on/off and brightness of the backlight unit 120.

The processor 140 may control general operation of the display apparatus 100.

The processor 140 may perform image processing with respect to the input content or the content stored in the display apparatus 100. In this case, the processor 140 may control the display panel 110 based on color information of the content, etc. In addition, the processor 140 may control the backlight driver 130 to control the backlight unit 120 to provide light to the display panel 110.

The processor 140 may control a driving signal to control a turn-on time point and a turn-off time point of the backlight unit 120. In this case, the backlight unit 120 may include a plurality of light sources, and the processor 140 may simultaneously control turn-on and turn-off time points of a plurality of light sources based on the driving signal. That is, turn-on and turn-off time points of the plurality of light sources may be the same.

The processor 140 may serially display a plurality of image frames. For example, the processor 140 may display a video.

In this case, the plurality of image frames may be identified based on at least one of a predetermined time unit, a scene unit, and a predetermined frame unit. For example, the processor 140 may identify the video into a plurality of groups by dividing the video into predetermined frame units. Each of a plurality of groups may include a plurality of image frames, and a plurality of image frames may be consecutive frames. If the number of entire frames of the video is 100 and a predetermined frame unit is 20, the processor 140 may identify the video into five groups, and each group may include 20 consecutive frames.

The processor 140 may identify a plurality of areas in an image frame among the plurality of image frames. In particular, the processor 140 may identify a plurality of areas in the image frame based on a scanning direction of an image signal. For example, when an image signal is serially scanned from the upper side to the lower side, the processor 140 may identify the frame into three equal areas: an upper area, a middle area, and a lower area.

However, this is only an example, and the processor 140 may identify the frame into a different number of areas. In addition, the processor 140 may identify the frame into a plurality of areas having different sizes.

The processor 140 may identify a plurality of image frames into a plurality of areas in the same way. For example, the processor 140 may identify a first frame among a plurality of image frames into three equal areas: an upper area, a middle area, and a lower area. In addition, the processor 140 may identify the rest of the plurality of frames into three equal areas as well: an upper area, a middle area, and a lower area.

The processor 140 may calculate a motion value corresponding to each of a plurality of areas, and drive a driving signal based on one of the plurality of areas according to the calculated motion value. For example, when each of a plurality of image frames is identified into an upper area, a middle area and a lower area, the processor 140 may calculate the amount of motion variation of the upper area among the plurality of image frames, calculate the amount of motion variation of the middle area, and calculate the amount of motion variation of the lower area. The processor 140 may control a driving signal based on one of the amount of motion variation of the upper area, the amount of motion variation of the middle area, and the amount of motion variation of the upper area that have been calculated.

The processor 140 may control a driving signal based on an area having a maximum value among motion values corresponding to the plurality of areas. In other words, the processor 140 may control a driving signal based on an area where the change of the image is the most severe among the plurality of areas.

In this case, the driving signal is a PWM signal, and the processor 140 may adjust a duty cycle of the PWM signal based on one of the plurality of areas. For example, the processor 140 may adjust the duty cycle of the PWM signal so that transients do not occur for one of the plurality of areas. In other words, the processor 140 may adjust the duty cycle so that blur does not occur for one of the plurality of areas.

In this case, blur may occur in the remaining area of the plurality of areas. However, a motion value of the remaining area is less than that of the one of the plurality of areas and thus, when the duty cycle of the PWM signal is adjusted based on the one area, blur may be improved compared with the case where the duty cycle of the PWM signal is adjusted based on the remaining area.

The processor 140 may identify a target duty timing based on a scan timing of one of the plurality of areas, and adjust the duty cycle of the PWM signal based on the target duty timing. Specifically, the processor 140 may identify the target duty timing based on a scan timing of a predetermined scan line among a plurality of scan lines included in one of the plurality of areas.

In this case, the scan timing refers to a timing at which each scan line is scanned in one frame, and a plurality of scan lines in one frame may be serially scanned at predetermined time intervals. The detailed description of the above will follow.

The processor 140 may serially change the duty timing of a plurality of image frames based on the target duty timing. For example, when a difference between a current duty timing and a target duty timing is large, the processor 140 may gradually change the duty timing.

Meanwhile, the display apparatus 100 may store information on whether to change a current duty timing. For example, the display apparatus 100 may further include a register, and the processor 140 may store, in the register, information on whether to change a current duty timing.

For example, when the display apparatus 100 includes a 10-bit register and a value of the register is 1, the display apparatus 100 may change the duty timing by 0.1 ms. However, this is only an example, and a capacity of the register and a degree of which the duty timing is changed may vary.

In this case, the register may be a high-speed exclusive storage which temporarily stores a small-capacity data and an intermediate result being processed.

However, the example is not limited thereto, and the display apparatus 100 may also store information on whether to change a current duty timing in a different type of storage such as HDD, SDD, RAM, and the like.

As described above, the processor 140 may change the duty timing of the driving signal based on an area having a large motion value in the image, thereby minimizing motion blur.

Hereinafter, an operation of the display apparatus 100 will be described in detail with reference to the drawings.

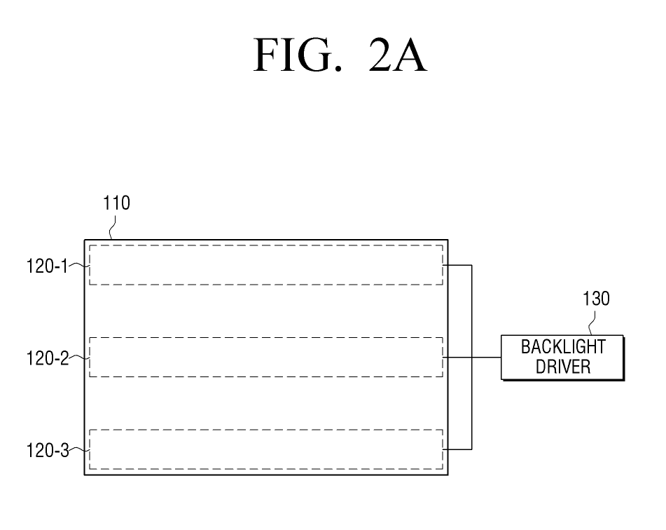

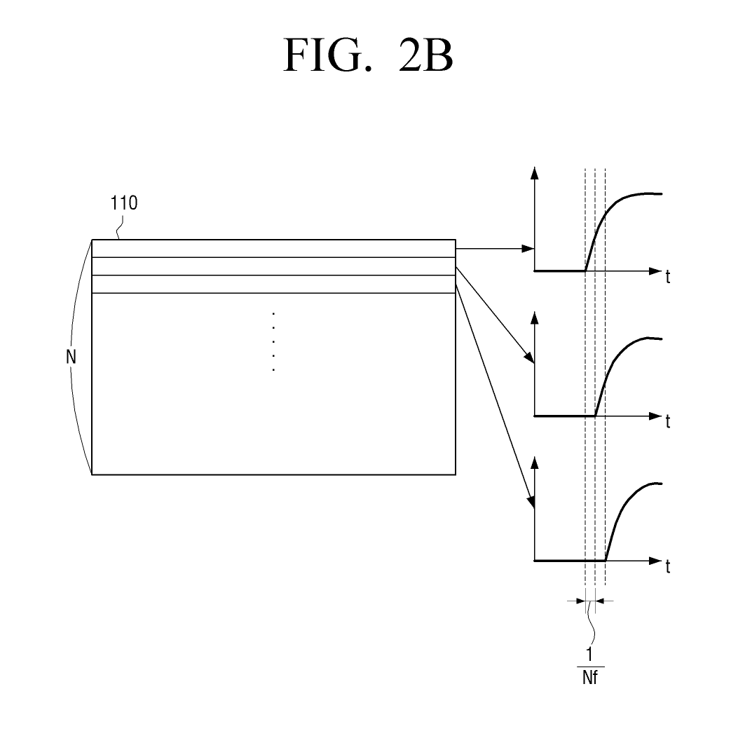

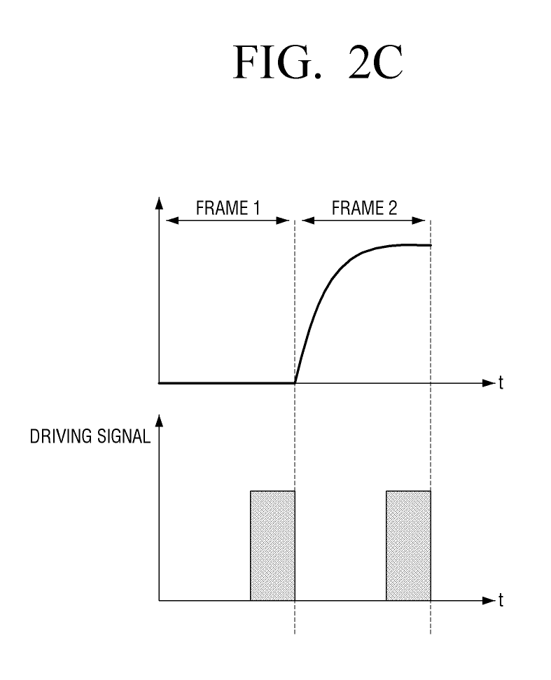

FIGS. 2A to 2C are diagrams illustrating operations of a display apparatus 100 according to an exemplary embodiment.

FIG. 2A is a diagram illustrating an operation of a backlight unit 120. The backlight unit 120 may be disposed on the rear side of the display panel 110.

The backlight unit 120 may include a plurality of light sources 120-1, 120-2 and 120-3. The plurality of light sources 120-1, 120-2 and 120-3 illustrated in FIG. 2A are merely an example, and the backlight unit 120 may include a plurality of light sources of different shapes.

For example, the backlight unit 120 may also include a plurality of light sources arranged on the edge of the display panel 110. In addition, the backlight unit 120 may include a plurality of light sources on the rear surface of the display panel 110. If the backlight unit 120 includes a plurality of light sources, its shape is irrelevant.

The backlight driver 130 may generate a driving signal, and apply the generated driving signal to a plurality of light sources 120-1, 120-2 and 120-3. The backlight driver 130 applies one driving signal to the plurality of light sources 120-1, 120-2 and 120-3 and thus, turn-on and turn-off time points of the plurality of light sources 120-1, 120-2 and 120-3 may be the same. In this case, an operation of the backlight driver 130 may be controlled by the processor 140.

However, the display panel 110 has a scan timing per line and thus, when the plurality of light sources 120-1, 120-2 and 120-3 are simultaneously turned on or turned off, a turn-on time point of the plurality of light sources 120-1, 120-2 and 120-3 and a scan timing of a specific line may not coincide with each other.

FIG. 2B is a diagram illustrating a scan timing for each line of the display panel 110. In FIG. 2B, it is assumed that the display panel 110 includes N number of lines, and that the entire screen is changed from black to white.

The processor 140 may control each line of the display panel 110 to be serially operated. For example, the processor 140 may control the display panel 110 such that the first line of the display panel 110 is operated and after a time of 1/Nf second elapses, the second line of the display panel 110 is operated. In addition, the processor 140 may control the display panel 110 such that the second line of the display panel 110 is operated and after a time of 1/Nf second elapses, the third line of the display panel 110 is operated.

In this case, the f may be a frequency of the image content. In other words, a time for which one frame of the image content is displayed may be 1/f second. In addition, one frame may include N number of lines, and a time for which one line is operated may be a time of 1/Nf second. In other words, each line of the display panel 110 may have different scan timings.

The scan timing described in FIG. 2B is merely an example, and the way how the scan timing is set may vary. For example, the display panel 110 may be identified into odd and even lines. The odd lines may be serially scanned from the upper side to the lower side and the even lines may serially scanned again from the upper side to the lower side.

FIG. 2C is a diagram illustrating an optimal turn-on time point of the backlight unit 120 for one line. In FIG. 2C, it is also assumed that the entire screen is changed from black to white.

The display panel 110 may have a transition period in color change depending on the response characteristic. In other words, when an input signal is changed, the display panel 110 may require a response time for stably outputting a desired signal due to physical characteristics. In other words, the processor 140 may control a driving signal to turn on the backlight unit 120 for a stabilized outputting time of the display panel 110.

For example, when the display panel 110 is changed from black to white, a transition period in which a brightness is changed, such as gray, may be generated. The user may feel that the transition period is blurred, which may be an element that interrupts viewing experience.

Thus, an optimal turn-on time of the backlight unit 120 may be a saturation period entry time point which passed the transition period.

However, as illustrated in FIG. 2A, a plurality of light sources 120-1, 120-2 and 120-3 of the backlight unit 120 may be simultaneously turned on regardless of a position of the display panel 110. As illustrated in FIG. 2B, a scan timing of the display panel 110 may vary for each line. In other words, a turn-on time point of the backlight unit 120 for each line may not be an optimal turn-on time, and blur may occur in each line.

However, the processor 140 may control turn-on and turn-off time points of the backlight unit 120 to minimize blur, which will be described in more detail in the drawings below.

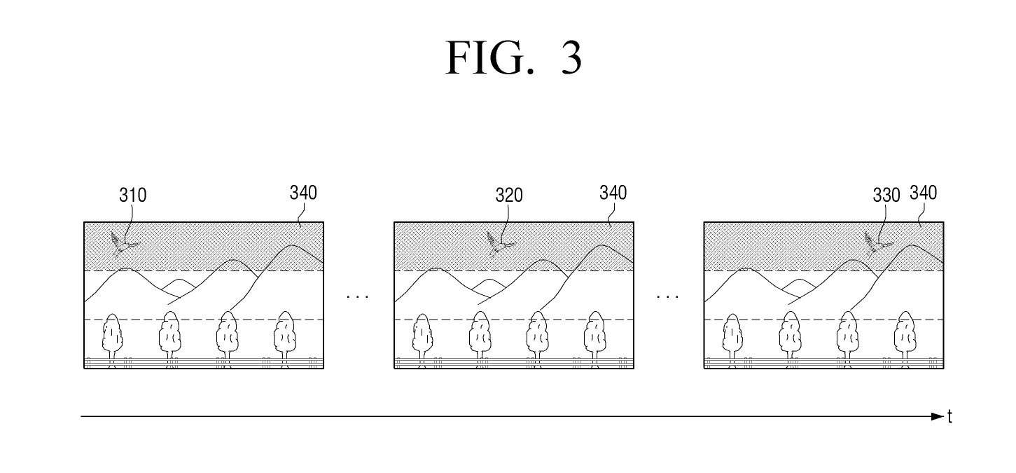

FIG. 3 is a diagram illustrating a method for setting a reference area according to an exemplary embodiment. In FIG. 3, a plurality of image frames may be identified based on at least one of a predetermined time unit, a scene unit, and a predetermined frame unit. The plurality of image frames may be a part of the entire video. In other words, the processor 140 may identify the entire video into a plurality of groups, and each group may include the same number of image frames.

As illustrated in FIG. 3, the processor 140 may identify each of a plurality of image frames into a plurality of areas, and calculate a motion value corresponding to each of the plurality of areas. For example, the processor 140 may identify each of the plurality of image frames into three equal areas: upper area 340, middle area and lower area. In addition, the processor 140 may calculate a motion value corresponding to each of the areas.

In this case, the processor 140 may identify each of a plurality of image frames into a plurality of areas based on a scanning direction of an image signal. For example, a scanning direction of the image signal is directed from the upper side to the lower side of the display panel, and the processor 140 may identify each of a plurality of image frames into a plurality of areas based on a direction perpendicular to the scanning direction of the image signal.

There is no image change in the middle area and the lower area from the left frame to the right frame through the middle frame, and the image in the upper area 340 changes. The processor 140 may detect a bird flitting operation 310, 320 and 330 in the upper area 340, and calculate a motion value of the upper area 340. The motion values of the middle area and the lower area may be zero (0) since there is no image change.

The processor 140 may analyze all of the plurality of image frames to calculate a motion value with respect to each of a plurality of areas. In addition, the processor 140 may acquire some frames among the plurality of image frames, and calculate a motion value of each of the plurality of areas using only the acquired frames. For example, the processor 140 may calculate a motion value with respect to each of the plurality of areas using the first frame and the last frame among the plurality of image frames.

In addition, the processor 140 may calculate a motion value based on a partial area of each of the plurality of areas. For example, the processor 140 may identify each of a plurality of image frames into three equal areas: upper area 340, middle area and lower area. In addition, the processor 140 may identify the middle area into a left area, a middle area and a right area, and calculate a motion value based on any one area. The processor 140 may apply the same operation to the upper area 340 and the lower area to calculate a motion value corresponding to each of the areas.

The processor 140 may calculate a motion value by analyzing a pixel value included in each of the plurality of areas. For example, the processor 140 may calculate a motion value based on variation of a pixel area.

In addition, the processor 140 may detect a main object included in each of the plurality of areas, and calculate a motion value based on each of the main objects.

The processor 140 may acquire some frames among a plurality of image frames to calculate a motion value between the acquired frames. For example, the processor 140 may calculate a motion value by comparing the first frame and the last frame among a plurality of image frames identified by scene.

However, the example is not limited thereto, and the processor 140 may also calculate a motion value by analyzing all of the plurality of image frames.

The processor 140 may set an area having a maximum value among motion values corresponding to the plurality of areas as a reference area. The processor 140 may control a driving signal based on a reference area.

In this case, the driving signal is a PWM signal, and the processor 140 may adjust a duty cycle of the PWM signal based on a reference area. However, this is only an example, and the driving signal may be a signal of a different shape. For example, a driving signal may be a sinusoidal wave, and the processor 140 may adjust at least one of the phase, amplitude, and frequency of the sine wave based on the reference area. A method of controlling a driving signal will be described below.

The processor 140 may identify a reference area in a plurality of image frames, and control a driving signal based on the reference area while all of the plurality of image frames are displayed. For example, the processor 140 may calculate a motion value by acquiring some frames among a plurality of image frames, and when a reference area is identified based on the calculated motion value, control a driving signal based on the reference area while all of the plurality of image frames are displayed.

However, the example is not limited thereto. For example, the processor 140 may calculate a motion value by analyzing all of a plurality of image frames, and when a reference area is identified based on the calculated motion value, some of the plurality of image frames might have been displayed due to a large amount of computation.

In this case, when computation is complete and a reference area is identified, the processor 140 may control a driving signal based on the reference area while the remaining frames that are not displayed among the plurality of image frames are displayed.

In addition, the processor 140 may change a method of calculating a motion amount to display all of the plurality of image frames based on the corresponding reference area. For example, to display all of a plurality of image frames based on the corresponding reference area, the processor 140 may also calculate a motion amount using only some of the plurality of frames so that a motion amount is calculated before the first frame among the plurality of image frames is displayed.

FIG. 3 illustrates a case where a plurality of areas have different motion values, but this is only an example. If there are two or more areas corresponding to the largest value as in the case where the plurality of areas have the same motion value, the processor 140 may identify a reference area based on an image.

For example, the processor 140 may identify a lower area as a reference area if the image has a caption. In addition, the processor 140 may identify the middle area among the upper area, the middle area, and the lower area as a reference area if the image does not have a predetermined characteristic.

In addition, the processor 140 may identify a reference area based on an image even in the case where a difference between the largest value and the second largest value among motion values of a plurality of areas is within a predetermined value.

Meanwhile, the processor 140 may not calculate a motion amount according to content to be displayed. For example, the processor 140 may identify the lower area as a reference area if content has a caption, and the processor 140 may identify the middle area as a reference area if the image does not have a predetermined characteristic.

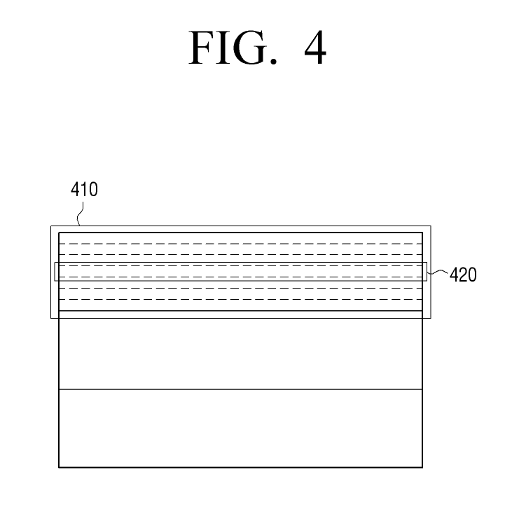

In addition, when the number of scenes is larger than that of other contents for the same time period, such as advertisement, etc., the processor 140 may not use a motion amount of the previous frame in consideration of the fact that the inter-frame change is severe. FIG. 4 is a diagram illustrating a reference of target duty timing according to an exemplary embodiment.

As illustrated in FIG. 4, the processor 140 may identify a target duty timing based on a scan timing of one of the plurality of areas, and adjust the duty cycle of the PWM signal based on the target duty timing. In this case, one of the plurality of areas may be a reference area of FIG. 4. In addition, the scan timing is as described in FIG. 2B.

The processor 140 may identify the target duty timing based on a scan timing of a predetermined scan line among a plurality of scan lines included in one of the plurality of areas. For example, the processor 140 may identify a target duty timing based on a scan timing of the middle scan line 420 in the upper area 410 of the plurality of areas.

It is illustrated in FIG. 4 that the upper area 410 has seven scan lines, but this is only an example, and the upper area 410 has a different number of scan lines. In addition, the processor 140 may identify a target duty timing based on a scan timing of the lowest scan line in the upper area 410 of the plurality of areas.

The processor 140 may identify a predetermined scan line among a plurality of scan lines included in a reference area based on a motion value of another area. For example, when the upper area 410 is a reference area and a motion value of the middle area is greater than a predetermined value, the processor 140 may identify a target duty timing based on a scan timing of the lowest scan line in the upper area 410. In addition, when the upper area 410 is a reference area and a motion value of the middle area is less than a predetermined value, the processor 140 may identify a target duty timing based on a scan timing of the middle scan line 420 in the upper area 410.

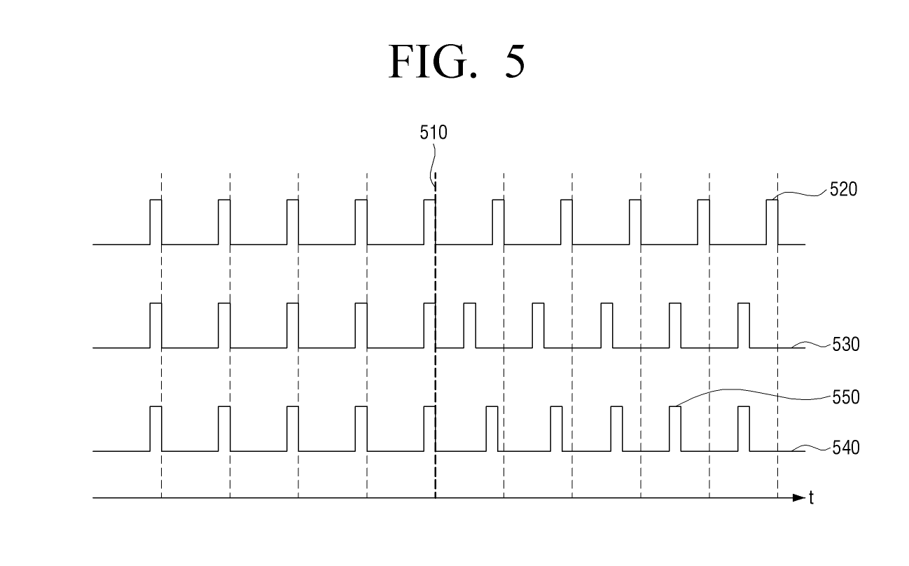

FIG. 5 is a diagram illustrating a method of controlling a driving signal according to an exemplary embodiment. In this case, it is assumed that a driving signal is a PWM signal. It is assumed that a time before the first time 510 is a period of a plurality of first image frames and a period after the first time 520 is a period of a plurality of second image frames.

The first driving signal 520 is a signal with no change in a duty cycle. The first driving signal 520 may be a waveform of a conventional driving signal. In addition, the first driving signal 520 may be a waveform of a driving signal in the case where there is no change in the reference area and the predetermined scan line even though the first driving signal 520 is changed to a plurality of second image frames.

The second driving signal 530 may have change in a duty cycle and may be a waveform of the driving signal when the target duty timing is changed immediately when the second driving signal 530 is changed to a plurality of second video frames. However, the duty cycle can be suddenly changed to cause a backlight flicker, and the user can feel an uncomfortable feeling.

The second driving signal 540 may have change in a duty cycle and may be changed to a plurality of second image frames, and may be a waveform of a driving signal of which a duty cycle is sequentially changed. That is, the processor 140 may sequentially change a duty timing of a plurality of image frames based on the target duty timing.

For example, when a difference between a current duty timing and a target duty timing exceeds a predetermined value, the processor may change the duty cycle as much as the predetermined value each time a frame is displayed.

In this case, the processor 140 may identify a duty change amount of a time when each frame is displayed by applying a filter to the target duty timing. For example, the processor 140 may identify a duty change amount of a time when each frame is displayed by applying an IIR filter to the target duty timing.

As illustrated in FIG. 5, when a plurality of second image frames and four additional frames are displayed, the processor 140 may control a driving signal to output a waveform 550 corresponding to the target duty timing. However, this is only an example, and the duty cycle may be changed in a different way as well.

For example, the processor 140 may change the duty cycle exponentially. In addition, the processor 140 may change the duty cycle during the entire period of the plurality of image frames.

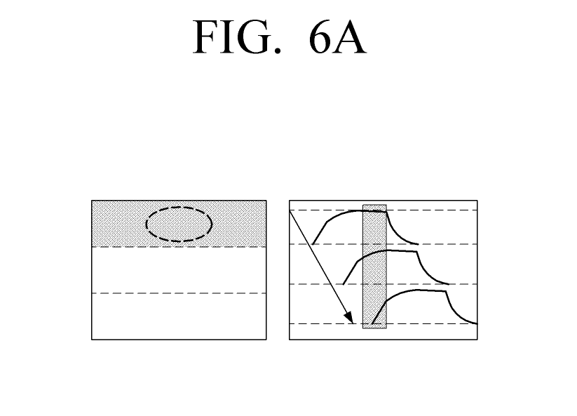

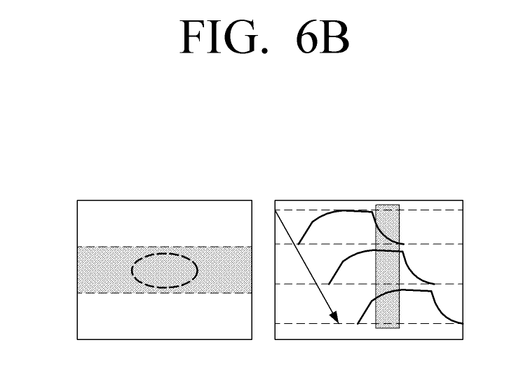

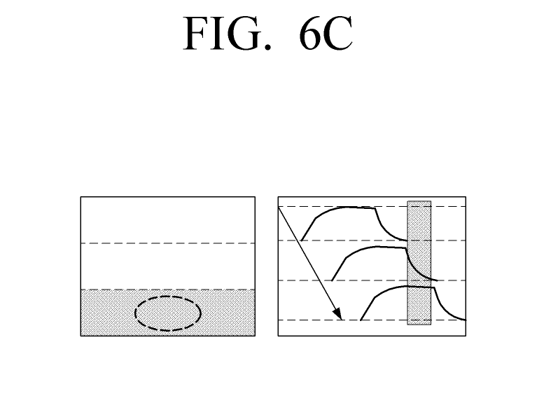

FIGS. 6A-6C are diagrams illustrating colors recognized by the user according to a turn-on or turn-off time point of the backlight unit 120 according to various exemplary embodiments. FIGS. 6A-6C illustrate that there is one response characteristic corresponding to each of an upper area, a middle area, and a lower area; however, the example is for the convenience of explanation, and there may actually be more response characteristics. In addition, it is assumed that the entire screen is changed from black to white and to black again and the image signal is sequentially scanned from the upper side to the lower side.

First, FIG. 6A illustrates an example in which the upper area is a reference area. In this case, the processor 140 may control a driving signal corresponding to a scan timing corresponding to the upper area. Accordingly, the upper area may be displayed in white color.

However, since a scan timing of the middle area and the lower area is later than that of the upper area, the middle area may be displayed darker than white color at a turn-on time point of the backlight unit 120, and the lower area may be displayed even darker than the middle area.

In the case where the middle area and the lower area are changed from black to gray, response characteristics of the middle area and the lower area are saturated at a lower value, and a transition period may be shortened. That is, if there is a little change in color in the middle area and the lower area, uncomfortable feeling of the user may be relatively reduced.

In addition, when the upper area is changed from black to white and the middle area and the lower area are changed from black to gray, uncomfortable feeling of the user may be relatively increased. In other words, areas in which a motion value is changed relatively largely are the middle area and the lower area; however, when the reference area is the upper area, the backlight unit 120 may be turned on before colors of the middle area and the lower area are changed and thus, accurate color representation may fail.

FIG. 6B illustrates an example in which the middle area is a reference area. In this case, the processor 140 may control a driving signal based on a scan timing corresponding to the middle area. Accordingly, the middle area may be displayed in white color.

However, since a scan timing of the upper area is faster than that of the middle area and a scan timing of the lower area is later than that of the middle area, the upper area may be displayed darker than white at a turn-on time point of the backlight unit 120, and the lower area may be displayed brighter than the upper area but darker than white color.

FIG. 6C illustrates an example in which the lower area is a reference area. In this case, the processor 140 may control a driving signal based on a scan timing corresponding to the lower area. Accordingly, the lower area may be displayed in white color.

However, since scan timings of the upper area and the middle area is faster than that of the lower area, the upper area is displayed in black color at a turn-on time point of the backlight unit 120, and the middle area may be displayed brighter than the upper area but darker than the lower area.

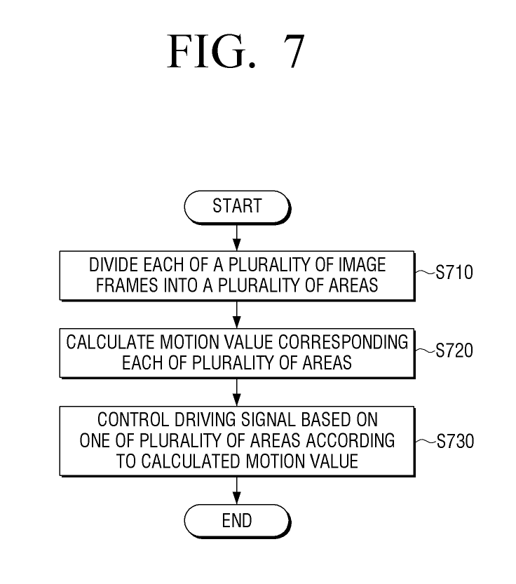

FIG. 7 is a flowchart illustrating a control method of the display apparatus according to an exemplary embodiment.

A controlling method of a display apparatus comprising a display panel, a backlight unit which provides (or emits light to the display panel, and a backlight driver which drives the backlight unit based on a driving signal, includes dividing each of a plurality of image frames into a plurality of areas, at operation S710. Then, a motion value corresponding to each of the plurality of areas is calculated at operation S720. Then, a driving signal is controlled based on one of the plurality of areas according to the calculated motion value, at operation S730.

In this case, the controlling S730 comprises controlling a driving signal based on an area having a largest value among motion values corresponding to the plurality of areas.

Meanwhile, the driving signal may be a PWM signal, and the controlling step S730 may include adjusting a duty cycle of the PWM signal based on one of the plurality of areas.

The controlling step S730 may include determining a target duty timing based on a scan timing of one of the plurality of areas, and adjusting the duty cycle of the PWM signal based on the target duty timing.

The controlling step S730 may include serially changing the duty timing of a plurality of image frames based on the target duty timing.

The controlling step S730 may include determining the target duty timing based on a scan timing of a predetermined scan line among a plurality of scan lines included in one of the plurality of areas.

Meanwhile, the dividing step S710 may including dividing a plurality of areas based on a scanning direction of an image signal.

In addition, the plurality of image frames may be identified based on at least one of a predetermined time unit, a scene unit, and a predetermined frame unit.

Meanwhile, a backlight unit may include a plurality of light sources, and the controlling method may further include simultaneously controlling turn-on time points of the plurality of light sources based on a driving signal.

According to the above-described various exemplary embodiments, a display apparatus may adaptively control the backlight unit based on the motion value of the image, thereby minimizing the blur and providing a clearer image to the user.

It is described in the above example that a scan direction of the display panel is from the upper side to the lower side, but the example is not limited thereto. For example, a scan direction of the display panel may be from the left side to the right side. In this case, the processor 140 may identify each of a plurality of image frames into a left area, a middle area and a right area.

It is assumed in the above example that the display apparatus is operated in a Vsync Lock mode. That is, it is described that the display apparatus is operated in the Vsync Lock mode and a duty cycle begins based on Vsync. However, this is only an example, and when the display apparatus is operated in a Free Run mode, the processor may self-control the duty cycle to correspond to a point at which the duty cycle begins.

The methods according to various exemplary embodiments may be programmed and stored in various storage media. Accordingly, the methods according to the above-mentioned various exemplary embodiments may be realized in various types of electronic apparatuses to execute a storage medium.

Specifically, a non-transitory computer-readable medium where a program for performing the above-described controlling method sequentially may be provided.

The non-transitory computer readable medium refers to a medium that stores data semi-permanently rather than storing data for a very short time, such as a register, a cache, a memory or etc., and is readable by an apparatus. In detail, the above-described various applications or programs may be stored in the non-transitory computer readable medium, for example, a compact disc (CD), a digital versatile disc (DVD), a hard disc, a Blu-ray disc, a universal serial bus (USB), a memory card, a read only memory (ROM), and the like, and may be provided.

For example, at least one of these components, elements, modules or units may use a direct circuit structure, such as a memory, a processor, a logic circuit, a look-up table, etc. that may execute the respective functions through controls of one or more microprocessors or other control apparatuses.

What is claimed is:

1. A display apparatus, comprising:
a display panel;
a backlight unit configured to provide light to the display panel; and
a processor configured to:
identify a plurality of areas in an image frame,
calculate a motion value corresponding to each of the plurality of areas, and
control a driving signal for driving the backlight unit based on one of the plurality of areas according to the calculated motion value.

2. The display apparatus as claimed in claim 1, wherein the processor controls the driving signal based on an area having a largest value among motion values corresponding to the plurality of areas.

3. The display apparatus as claimed in claim 1, wherein the driving signal is a pulse width modulation (PWM) signal, and
wherein the processor adjusts a duty cycle of the PWM signal based on one of the plurality of areas.

4. The display apparatus as claimed in claim 3, wherein the processor identifies a target duty timing based on a scan timing of one of the plurality of areas, and adjusts a duty cycle of the PWM signal based on the target duty timing.

5. The display apparatus as claimed in claim 4, wherein the processor sequentially changes a duty timing of a plurality of image frames based on the target duty timing.

6. The display apparatus as claimed in claim 4, wherein the processor identifies the target duty timing based on a scan timing of a predetermined scan line among a plurality of scan lines included in one of the plurality of areas.

7. The display apparatus as claimed in claim 1, wherein the processor identifies the plurality of areas based on a scanning direction of an image signal corresponding to the image frame.

8. The display apparatus as claimed in claim 1, wherein the processor identifies a plurality of areas in each of a plurality of image frames, and
wherein the plurality of image frames are identified based on at least one of a predetermined time unit, a scene unit, and a predetermined frame unit.

9. The display apparatus as claimed in claim 1, wherein the backlight unit includes a plurality of light sources, and
wherein the processor simultaneously controls a turn-on time point of the plurality of light sources based on the driving signal.

10. A controlling method of a display apparatus including a display panel and, a backlight unit configured to provide light to the display panel, the method comprising:
identifying a plurality of areas in an image frame;
calculating a motion value corresponding to each of the plurality of areas; and
controlling a driving signal for driving the backlight unit based on one of the plurality of areas according to the calculated motion value.

11. The controlling method as claimed in claim 10, wherein the controlling comprises controlling the driving signal based on an area having a largest value among motion values corresponding to the plurality of areas.

12. The controlling method as claimed in claim 11, wherein the driving signal is a PWM signal, and
wherein the controlling comprises adjusting a duty cycle of the PWM signal based on one of the plurality of areas.

13. The controlling method as claimed in claim 12, wherein the controlling comprises determining a target duty timing based on a scan timing of one of the plurality of areas, and adjusting a duty cycle of the PWM signal based on the target duty timing.

14. The controlling method as claimed in claim 13, wherein the controlling comprises sequentially changing a duty timing of a plurality of image frames based on the target duty timing.

15. The controlling method as claimed in claim 13, wherein the controlling comprises identifying the target duty timing based on a scan timing of a predetermined scan line among a plurality of scan lines included in one of the plurality of areas.

16. The controlling method as claimed in claim 10, wherein the dividing comprises identifying the plurality of areas based on a scanning direction of an image signal corresponding to the image frame.

17. The controlling method as claimed in claim 10, wherein the identifying identifies a plurality of areas in each of a plurality of image frames, and
wherein the plurality of image frames are identified based on at least one of a predetermined time unit, a scene unit, and a predetermined frame unit.

18. The controlling method as claimed in claim 10, further comprising:
simultaneously controlling a turn-on time point of the plurality of light sources based on the driving signal,
wherein the backlight unit includes a plurality of light sources.

19. A non-transitory recording medium storing a program for executing an operation method of a display apparatus including a display panel, and a backlight unit configured to provide light to the display panel,
wherein the operation method comprises:
identifying a plurality of areas in an image frame;
calculating a motion value corresponding to each of the plurality of areas; and
controlling a driving signal for driving the backlight unit based on one of the plurality of areas according to the calculated motion value.
